(19) United States
(12) Patent Application Publication
(10) Pub. No.: US 2011/0241455 A1
(43) Pub. Date: Oct. 6, 2011

(54) Magnetic Shield for Stator Core End Structures of Electric Rotating Machine

(75) Inventors: Jun YOSHIDA, Hitachi (JP); Akihito Nakahara, Hitachi (JP); Akiyoshi Komura, Hitachi (JP)

(73) Assignee: HITACHI, LTD., Tokyo (JP)

(21) Appl. No.: 13/026,706

(22) Filed: Feb. 14, 2011

(30) Foreign Application Priority Data
Mar. 31, 2010 (JP) 2010-080061

(51) Int. Cl. H02K 1/18; H02K 1/02

(52) U.S. Cl. 310/44; 310/216.114

(57) ABSTRACT

In an electric rotating machine, for reducing losses that occur in clamping plates and their shield, the electric rotating machine includes a rotor formed with field winding wound around a rotor core, a stator placed opposite to the rotor at a predetermined space and formed with stator winding wound around a stator core formed by stacking multiple magnetic steel sheets in the axial direction, clamping plates clamping and retaining the stator core from both axial end parts thereof in the stacking direction of the magnetic steel sheets, and a magnetic shield placed around the clamping plates to shield flux leakage flowing into the clamping plates, and the magnetic shield is formed of a cylinder of stacked steel sheets stacked in a form of a cylinder about the rotor shaft and powder magnetic core segments and powder magnetic core segments having portions which are stuck to the cylinder of stacked steel sheets on the stacking cross section, and arranged to cover side surfaces and an inner surface of radial direction of the clamping plates.

### BACKGROUND OF THE INVENTION

(1) Field of the Invention

The present invention relates to an electric rotating machine. For example, it relates to an electric rotating machine suitable for a structure in which a stator core adopted in a turbine generator or the like as a large electric rotating machine is formed by stacking plural magnetic steel sheets and clamped by clamping plates which apply presser on a stator core in a stacking direction from axial end parts.

(2) Description of Related Art

A conventional example will be described by taking, as an example, a turbine generator as a large electric rotating machine.

FIG. 1 and FIG. 2 show the schematic structure of the turbine generator. The turbine generator shown in the figures is constituted roughly of a rotor 3 formed by winding field winding around a rotor core and a stator 100 placed opposite to this rotor 3 at a predetermined space and formed by winding stator winding 4 around a stator core 1.

The stator core 1 has a cylindrical shape formed by punching out multiple fan-shaped segments of magnetic steel sheets from a steel strip and stacking the segments in an axial direction while lining up the segments in a circumferential direction to form a circle. This stator core 1 is clamped and retained between clamping plates 2 (generally iron casts are used) from both axial end parts in a stacking direction of the magnetic steel sheets. Then, as shown in FIG. 2, each of hanging bars 6 for retaining the stator core 1 is put around the outer part of the stator core 1 in a radial direction, and this hanging bar 6 is jointed to the clamping plates 2 at the axial end parts.

Further, as shown in FIG. 3 and FIG. 4, another way of fixing the stator core 1 is such that through bolts 17 which apply pressure on a stator core in a stacking direction are passed through the stator core 1 and the clamping plates 2 instead of the hanging bars shown in FIG. 1 and FIG. 2 and clamped at the end parts to retain the stator core 1. In this example, the clamping plates 2 are also made of an iron material.

In the meantime, since the clamping plates are generally made of iron and magnetized, a relatively large amount of flux leakage can flow into the clamping plates from the rotor and the stator winding as the sources of magnetic flux. In addition, since the clamping plates are massive, eddy current caused by the inflow magnetic flux is large to cause a problem of an increase in heat generation due to eddy current loss and hence reduction in efficiency.

Therefore, in order to reduce the amount of magnetic flux flowing into the clamping plates, JP-A-2006-320100 teaches that auxiliary magnetic bodies such as stacked steel plates having higher magnetic permeability than the clamping plates are attached as magnetic shield onto the surface of the clamping plates. In JP-A-2006-320100, the auxiliary magnetic bodies are attached as the magnetic shield onto the clamping plates so that the shield will attract flux leakage in the axial end parts to reduce the amount of magnetic flux that invades the inside of the clamping plates so as to reduce eddy current losses that occur in the clamping plates.

The stacked steel sheets have a reduced sheet thickness to reduce the eddy current due to the magnetic flux that passes through the planes. Meanwhile, when the magnetic flux flows from the stacking direction, eddy current flows into the steel sheet planes, causing great eddy current loss.

The technique in the above-mentioned publication could cause eddy current loss because the magnetic flux flows into the magnetic shield from the stacking direction.

Further, in order to reduce the amount of magnetic flux flowing into the clamping plates, US 2007/0262658 A1 teaches use of a low-conductivity magnetic body, such as a powder magnetic core, for a magnetic shield to reduce the eddy current loss in the shield. Since the powder magnetic core described in this publication is formed by compressing dielectrically-coated iron powder, the eddy current flows only into each powder, reducing the eddy current loss due to the inflow of the magnetic flux.

As mentioned above, use of the powder magnetic core can suppresses the eddy current loss, but the powder magnetic core has lower saturation magnetic flux density and higher hysteresis loss than the stacked steel sheets. This causes big loss in the shield itself.

Therefore, it needs to be heavier in weight than the stacked steel sheets to reduce the magnetic flux density in order to keep the loss equivalent to that in the shield using the stacked steel sheets.

Further, JP-A-60-245436 teaches that the surface of clamping plates is covered with a plate-shaped conductor to reduce the eddy current loss in the clamping plates. JP-A-60-245436 is to use the reaction of eddy current in the conductor plate to reduce the flow of magnetic flux into the clamping plates.

However, in a large electric rotating machine such as a turbine generator, the frequency of magnetic flux is 50 or 60 Hz, and when copper is used for the conductor plate, the skin depth is about 10 mm. A sheet thickness equal to or more than the skin depth is required to block the flow of magnetic flux into the clamping plates. Further, an electromagnetic shield using the conductor plate is required to cover the whole surface of the clamping plates, and these increase the weight of the shield plate.

Further, U.S. Pat. No. 4,054,809 teaches that a wire of a magnetic material assumes the form of a large ring around a rotating shaft, and a lot of the rings are encased in resin and arranged near the clamping plates to form a magnetic shield. In U.S. Pat. No. 4,054,809, respective wires are arranged apart to make it hard for eddy current to flow even if magnetic flux flows into the shield.

However, since it is difficult to increase the space factor of the wires in the shield, the amount of magnetic flux allowed to flow is small from the standpoint of the entire magnetic shield and the effect of blocking the flow of the magnetic flux into the clamping plates is low.

The above-mentioned conventional examples have a problem of large losses that occur in the clamping plates and the shield. In the magnetic shield using the steel sheets described in JP-A-2006-320100, the eddy current loss in the shield itself is large due to the inflow of magnetic flux from the stacking direction. Use of the conductor plate as in US 2007/0262658 A1 is required to cover the entire surface of the clamping plates with the conductor plate, resulting in the need to be heavy in weight. In JP-A-60-245436, the weight of the powder magnetic core used as the magnetic shield becomes heavy, and in U.S. Pat. No. 4,054,809, the effect of the magnetic shield to attract magnetic flux is low.

### BRIEF SUMMARY OF THE INVENTION

The present invention has been made in view of the above-mentioned points, and it is an object thereof to provide an electric rotating machine capable of reducing losses that occur in clamping plates and their shield.

In order to attain the above object, an electric rotating machine according to the present invention includes a rotor formed with field winding wound around a rotor core, a stator placed opposite to the rotor at a predetermined space and formed with stator winding wound around a stator core formed by stacking multiple magnetic steel sheets in the axial direction, clamping plates clamping and retaining the stator core from both axial end parts thereof in the stacking direction of magnetic steel sheets, and a magnetic shield placed around the clamping plates to shield flux leakage flowing into the clamping plates, wherein the magnetic shield is formed of a cylinder of stacked steel sheets stacked in the form of a cylinder about the rotor shaft and powder magnetic core segments having portions which are stuck to the cylinder of stacked steel sheets on the stacking cross section, and the magnetic shield is arranged to cover side surfaces and inner surface of radial direction of the clamping plates.

According to the electric rotating machine of the present invention, losses that occur in the clamping plates and their shield can be reduced.

Other objects, features and advantages of the invention will become apparent from the following description of the embodiments of the invention taken in conjunction with the accompanying drawings.

### BRIEF DESCRIPTION OF THE SEVERAL VIEWS OF THE DRAWING

FIG. 1 is a sectional view showing a turbine generator in the circumferential direction as an example of a conventional electric rotating machine;

FIG. 2 is a sectional view taken along II-II in FIG. 1 (note that stator winding is omitted);

FIG. 3 is an enlarged view of a stator end part, showing another example of fixing a stator core;

FIG. 4 is a view seen from a direction of an arrow IV in FIG. 3 (note that stator winding is omitted);

FIG. 5 is an enlarged sectional view of a stator end part, showing a turbine generator as Embodiment 1 of an electric rotating machine according to the present invention:

FIG. 6 is an enlarged sectional view of the stator end part, showing a flow of magnetic flux around a magnetic shield in Embodiment 1;

FIG. 7 is an enlarged sectional view of the stator end part in Embodiment 1, where the dimensions of each part of the magnetic shield are defined;

FIG. 8 is a view seen from a direction of an arrow VIII in FIG. 5;

FIG. 9 is a view corresponding to FIG. 8, showing Embodiment 2 of an electric rotating machine according to the present invention;

FIG. 10 is a partial sectional view of power magnetic core segments, showing a modification of Embodiment 2;

FIG. 11 is a sectional view taken along an X1-XI line in FIG. 10;

FIG. 12 is a partial sectional view of power magnetic core segments, showing another modification of Embodiment 2;

FIG. 13 is an enlarged sectional view of a stator end part, showing Embodiment 3 of an electric rotating machine according to the present invention;

FIG. 14 is an enlarged sectional view of a stator end part, showing a modification of Embodiment 3;

FIG. 15 is an enlarged sectional view of a stator end part, showing Embodiment 4 of an electric rotating machine according to the present invention;

FIG. 16 is an enlarged sectional view of a stator end part, showing Embodiment 5 of an electric rotating machine according to the present invention;

FIG. 17 is a view of a stator end part, showing an example of assembling plates which support coils in a conventional electric rotating machine;

FIG. 18 is a view seen from a direction of an arrow XVIII in FIG. 17;

FIG. 19 is a view of a stator end part, showing Embodiment 6 of an electric rotating machine according to the present invention;

FIG. 20 is a view seen from a direction of an arrow XX in FIG. 19;

FIG. 21 is a view of a stator end part, showing Embodiment 7 of the electric rotating machine of the present invention;

FIG. 22 is a view of a stator end part, showing Embodiment 8 of an electric rotating machine according to the present invention;

FIG. 23 is a view seen from a direction of an arrow XXIII in FIG. 22;

FIG. 24 is a view corresponding to FIG. 23, showing Embodiment 9 of an electric rotating machine according to the present invention;

FIG. 25 is a sectional view taken along an XXV-XXV line in FIG. 24;

FIG. 26 is a view of a stator end part, showing Embodiment 10 of an electric rotating machine according to the present invention;

FIG. 27 is an enlarged view of a magnetic shield employed in Embodiment 10;

FIG. 28 is a view corresponding to FIG. 26, showing a modification of Embodiment 10;

FIG. 29 is a view of a stator end part, showing Embodiment 11 of an electric rotating machine according to the present invention;

FIG. 30 is an enlarged sectional view of a stator end part, showing Embodiment 12 of an electric rotating machine according to the present invention;

FIG. 31 is a view seen from an inner side of radial direction in FIG. 30;

FIG. 32 is an enlarged sectional view of a stator end part, showing Embodiment 13 of an electric rotating machine according to the present invention;

FIG. 33 is a view of a stator end part, showing a modification of Embodiment 13;

FIG. 34 is a view of a stator end part, showing Embodiment 14 of an electric rotating machine according to the present invention;

FIG. 35 is a view of a stator end part, showing a modification of Embodiment 14;

FIG. 36 is a view of a stator end part, showing Embodiment 15 of an electric rotating machine according to the present invention;

FIG. 37 is a view of a stator end part, showing Embodiment 16 of an electric rotating machine according to the present invention;

FIG. 38 is a view of a stator end part, showing Embodiment 17 of an electric rotating machine according to the present invention;

FIG. 39 is a view of a stator end part, showing Embodiment 18 of the electric rotating machine of the present invention;

FIG. 40 is a sectional view taken along an XL-XL line in FIG. 39; and

FIG. 41 is a view of a stator end part, showing Embodiment 19 of an electric rotating machine according to the present invention.

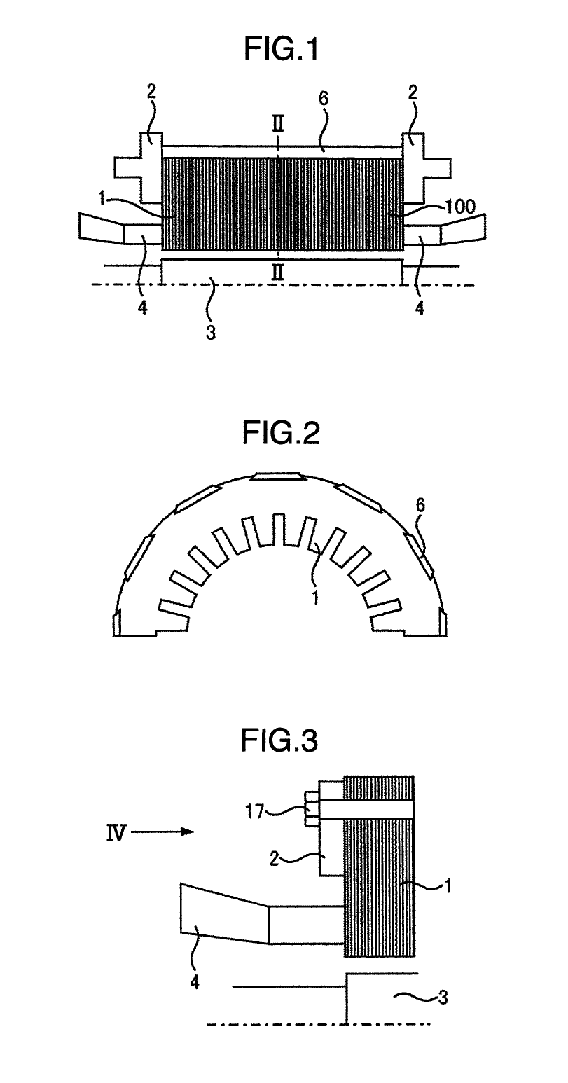

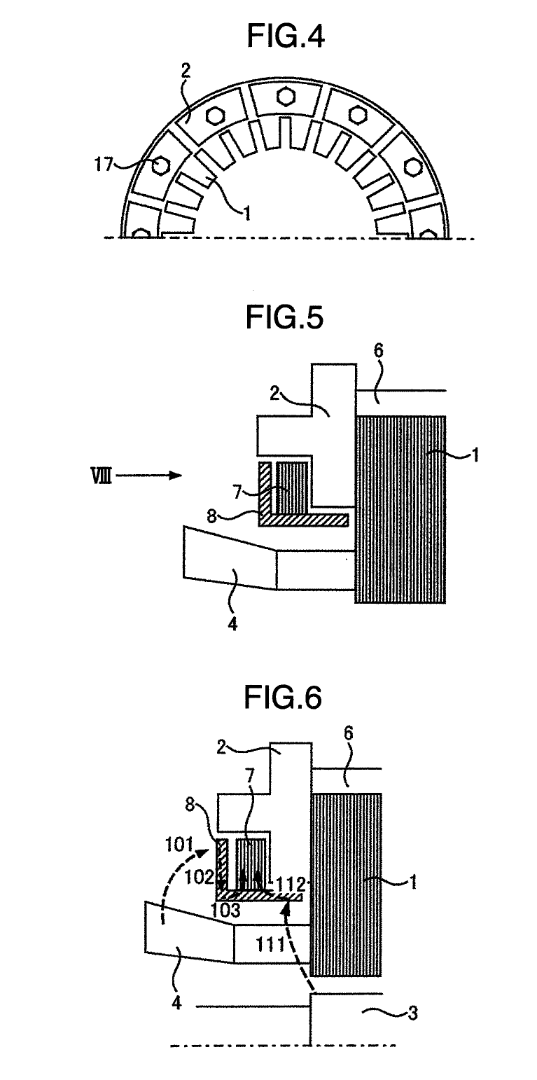

### DETAILED DESCRIPTION OF THE INVENTION

An electric rotating machine according to the present invention will now be described based on illustrated embodiments. Note that the same reference numerals are given to the same elements as those in the conventional electric rotating machine to omit redundant descriptions.

### Embodiment 1

FIG. 5 shows a stator end part of a turbine generator as an example of an electric rotating machine to which the present invention is applied.

As shown in the drawing, in this Embodiment, a magnetic shield using a cylinder 7 of stacked steel sheets stacked in the shape of a cylinder about a rotor shaft and a powder magnetic core segment 8 formed by compressing powder of dielectrically-coated magnetic material is attached to clamping plates 2 clamping a stator core 1 from both end parts in the stacking direction of magnetic steel sheets. This magnetic shield is arranged outside the outer side of radial direction of a stator winding 4 to cover the lateral sides and inner surface of radial direction of the clamping plates 2. When the magnetic shield is attached to the clamping plates 2, air gaps or nonmagnetic insulators are provided in the axial direction between the cylinder 7 of stacked steel sheets and the clamping plates 2 and between the cylinder 7 of stacked steel sheets and the powder magnetic core segment 8. The cylinder 7 of stacked steel sheets and the powder magnetic core segment 8 are stuck together in the radial direction of the stacking cross-section. The cylinder 7 of stacked steel sheets has high magnetic permeability and made of a material with low iron loss. For example, normal silicon steel sheets are used for the cylinder, but it may be an amorphous alloy with low iron loss.

Next, the operation of the structure of the embodiment will be described. FIG. 6 shows flux leakage flowing into the magnetic shield as indicated by broken arrows in the structure of Embodiment 1 shown in FIG. 5.

As indicated by the broken arrows in FIG. 6, when the flow of flux leakage at axial end parts from a rotor 3 and the stator winding 4 is headed to the clamping plates 2, magnetic flux flows into the powder magnetic core segment 8 having higher magnetic permeability than that of the clamping plates 2. The powder magnetic core segment 8 formed by compressing the dielectrically-coated magnetic material powder has low conductivity in any directions. Therefore, even when the magnetic flux flows in from any direction, eddy current is hardly produced due to the magnetic flux, resulting in small eddy current loss. The powder magnetic core segment 8 and the cylinder 7 of stacked steel sheets are stuck together in the radial direction. On the other hand, an air gap is provided in the axial direction, so that paths to the cylinder 7 of stacked steel sheets through the powder magnetic core segment 8 as indicated by arrows 102 to 103 have lower reluctance than that of a flux path from the powder magnetic core segment 8 to the cylinder 7 of stacked steel sheets in the axial direction. Therefore, the magnetic flux into the cylinder 7 of stacked steel sheets flows from the inner side of radial direction as indicated by arrow 103.

Air gaps are also provided between the powder magnetic core segment 8 and the stator core 1, and the clamping plates 2. Therefore, magnetic flux 111 that has entered the powder magnetic core segment 8 from the radial direction flows into the cylinder 7 of stacked steel sheets from the radial direction along a flux path 112, rather than flux paths traveling to the stacked steel sheets that form the stator core 1 or the clamping plates 2, because the flux path flowing into the cylinder 7 of stacked steel sheets as indicated by 112 has lower reluctance.

Here, if the cross-section area of a flux path is S, the length of the flux path is 1, and the magnetic permeability of material existing in the flux path is μ, reluctance R is calculated by the following equation:

R=1/(μ·S)

The air gaps between the clamping plates 2 and the cylinder 7 of stacked steel sheets are to prevent magnetic flux from running off from the cylinder 7 of stacked steel sheets toward the clamping plates 2 in the axial direction. The flux leakage flowing into the cylinder 7 of stacked steel sheets is divided into a path to return to a magnetic flux source after directly flowing inside of the cylinder 7 of stacked steel sheets in the circumferential direction and a path to flow from the cylinder 7 of stacked steel sheets into the clamping plates 2, return to the cylinder 7 of stacked steel sheets again after flowing inside the clamping plates 2 in the circumferential direction, and then return to the magnetic flux source.

Among magnetic flux passing through these paths, in order to reduce the amount of magnetic flux flowing from the cylinder 7 of stacked steel sheets into the clamping plates 2, the air gaps between the cylinder 7 of stacked steel sheets and the clamping plates 2 have only to be widened.

If the reluctance upon flowing half round inside the clamping plates 2 in the circumferential direction is Rc, the reluctance flowing half around the cylinder 7 of stacked steel sheets in the circumferential direction is Rs, and the reluctance of the air gaps between the clamping plates 2 and the cylinder 7 of stacked steel sheets is Rg, 2Rg+Rc/2>>Rs/2 is necessary.

In the coefficients of the reluctances, the reluctance of Rg is 2 because the path in the case of Rg passes through the air gap twice, and both reluctances of Rc and Rs become ½ considering that two paths in the cases of Rc and Rs are connected in parallel in the circumferential direction. Respective reluctances are expressed in terms of the cross-section areas of flux paths, flux path lengths and magnetic permeability as follows:

2lg1/(μ₀·Sg1)+1c/(2 μc·Sc)>>1s/(2 μs·Ss),

where μ₀ is vacuum magnetic permeability, μc and μS are the magnetic permeabilities of the clamping plates 2 and the cylinder 7 of stacked steel sheets, respectively, lg1 and Sg1 are the air gap length and the cross-section area of the flux path between the cylinder 7 of stacked steel sheets and the clamping plates 2, respectively, 1c is half the circumferential length of the clamping plates 2, Sc is the cross-section area of the flux path of the clamping plates in the circumferential direction, is half the circumferential length of the cylinder 7 of stacked steel sheets, and Ss is the cross-section area of the flux path of the cylinder 7 of stacked steel sheets in the circumferential direction. If a region through which magnetic flux passes from the cylinder 7 of stacked steel sheets to the clamping plates 2 is set as a region with angle π/2 of the cylinder 7 of stacked steel sheets, and a region through which magnetic flux returns from the clamping plates 2 to the cylinder 7 of stacked steel sheets is also set as the region with angle π/2, Sg1 is expressed by the following equation:

Sg1=Wp·R·π/2,

where R is a position of radial direction from the axis of rotation of the cylinder 7 of stacked steel sheets.

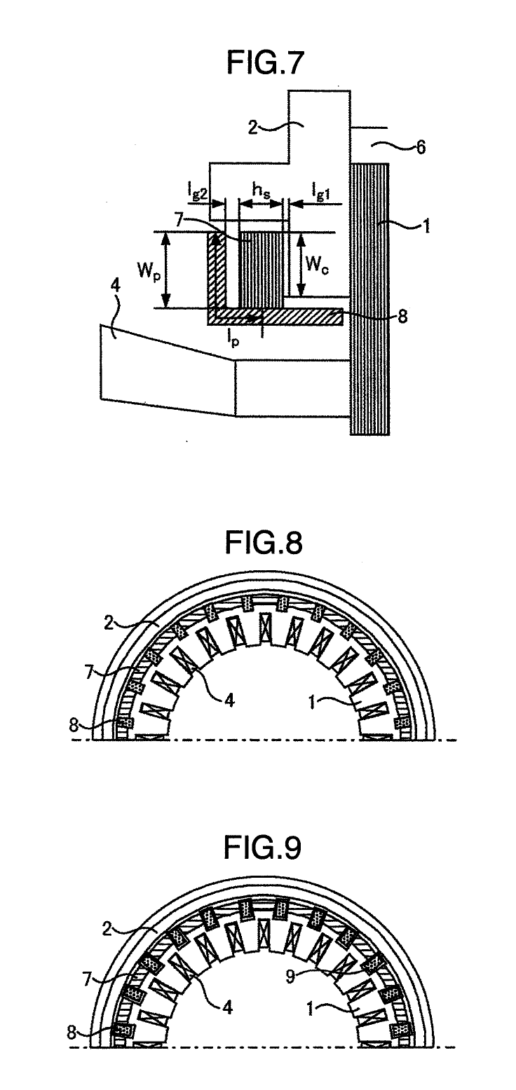

Further, if the dimensions shown in FIG. 7 are defined, Ss is expressed by the following equation:

Ss·=Wp·hs

Here, if the relative permeability between the cylinder 7 of stacked steel sheets and the clamping plates 2 is μr and 1s and 1c are approximated to be equal to π·R, the following equation is obtained:

lg1>>π²{1−Ss/(2·Sc)}/(8·μr·hs)

Assuming here that Ss and Sc are equal to each other considering that the flux path of the clamping plates 2 in the circumferential direction is only for the skin depth, the inside of the parentheses { } in the above equation is ½, and lg1 is expressed by the following equation:

lg1>>0.6·R²/(μr·hs))

Since the right-hand member of the above equation is the result of evaluation of the reluctance of the air gap as a small value, lg1 equal to or more than the right-hand member of the above equation is enough.

The air gap between the powder magnetic core segment 8 and the cylinder 7 of stacked steel sheets in the axial direction is provided to suppress the flow of magnetic flux from the powder magnetic core segment 8 into the cylinder 7 of stacked steel sheets in the axial direction. Among flux paths flowing from the powder magnetic core segment 8 to the cylinder 7 of stacked steel sheets, if the reluctance of the flux path flowing from the axial direction is Ra and the reluctance of the flux path flowing from the radial direction is Rr, the relation may be Ra>>Rr. The respective reluctances are expressed in terms of the cross-section areas of the flux paths, flux path lengths and magnetic permeability as follows:

lg2/(μₒ·Sg2)>>lp/(μp·Sp),

where lp and lg2 are dimensions defined in FIG. 7, Sp is the cross-section area of the flux path inside the powder magnetic core segment 8 and Sg2 is the cross-section area of the flux path in the air gap between the powder magnetic core segment 8 and the cylinder 7 of stacked steel sheets. Here, if the relative permeability of the powder magnetic core segment 8 is μr and the value obtained by dividing Sg2 by Sp is Sr, the following equation is obtained:

lg2>>1p·Sr/μr

Here, if lp in FIG. 7 is set to be about 1.2 times of Wp and Sr is Wp/hp, the above equation is expressed by the following equation:

lg2>>1.2·Wp²/(μr·hp)

Thus, lg2 equal to or more than the right-hand member of the above equation is enough.

The stacked steel sheets are such that eddy current due to magnetic flux flowing from the stacking cross section is small and eddy current due to magnetic flux flowing from the stacking direction is large. As mentioned above, air gaps are provided on both sides of the cylinder 7 of stacked steel sheets in the stacking direction to let magnetic flux flow from the radial direction as the direction of the stacking cross section, so that eddy current in the cylinder 7 of stacked steel sheets is suppressed and hence eddy current loss is reduced.

FIG. 8 shows a shape for half the circle as viewed from a direction VIII in FIG. 5. As shown, respective powder magnetic core segments 8 are spaced in the circumferential direction to make it hard for magnetic flux to flow inside each powder magnetic core segment 8 in the circumferential direction, and the flux path in the cylinder 7 of stacked steel sheets in the circumferential direction becomes longer than the flux path in the powder magnetic core segment 8 in the axial direction and radial direction.

In this embodiment, the reluctance of the powder magnetic core segment 8 in the circumferential direction is set larger than the reluctance of the cylinder 7 of stacked steel sheets in the circumferential direction and the magnetic flux flowing inside the powder magnetic core segment 8 in the circumferential direction is made small so that most of magnetic flux of circumferential direction will flow inside the cylinder 7 of stacked steel sheets smaller in loss than the powder magnetic core segment 8, thereby reducing loss in the powder magnetic core segment 8.

The flux leakage flowing into the powder magnetic core segment 8 flows into the cylinder 7 of stacked steel sheets, travels inside the cylinder 7 of stacked steel sheets in the circumferential direction, and returns to the rotor 3 as the magnetic flux source and the stator winding 4 through the powder magnetic core segment 8. Since the cylinder 7 of stacked steel sheets has smaller iron loss than that of the clamping plates 2 and the powder magnetic core segment 8, the flux leakage returns to the magnetic flux source with low loss. As discussed above, the flow of magnetic flux into the clamping plates 2 is reduced and the loss in the magnetic shield is also reduced. This reduction in loss leads to a high-efficient electric rotating machine.

### Embodiment 2

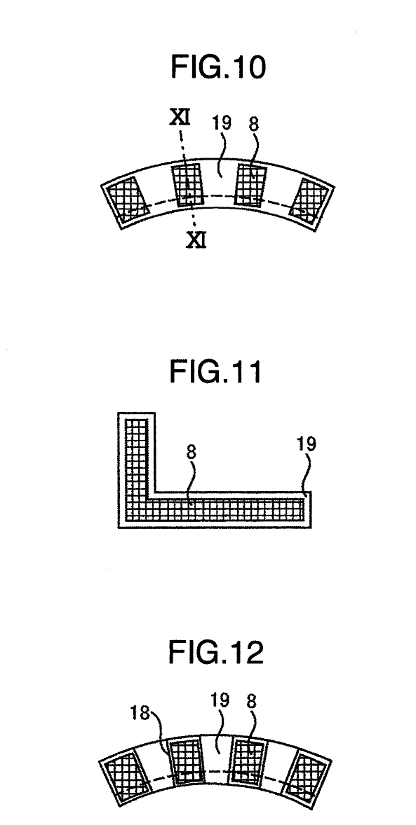

As shown in FIG. 9, the surface of each of the powder magnetic core segments 8 in Embodiment 1 is covered with resin or each of the powder magnetic core segments 8 is housed in a resin case 9 for a single segment so as to prevent iron powder of the powder magnetic core from scattering. Further, as shown in FIG. 10 and FIG. 11, multiple powder magnetic core segments 8 are housed in a resin case 19 for multiple segments so that the number of parts can be reduced, making the setting easy.

Further, in order to prevent the powder magnetic core segments 8 from moving in the case 19, grooves 18 may be formed in the case 19 as shown in FIG. 12.

### Embodiment 3

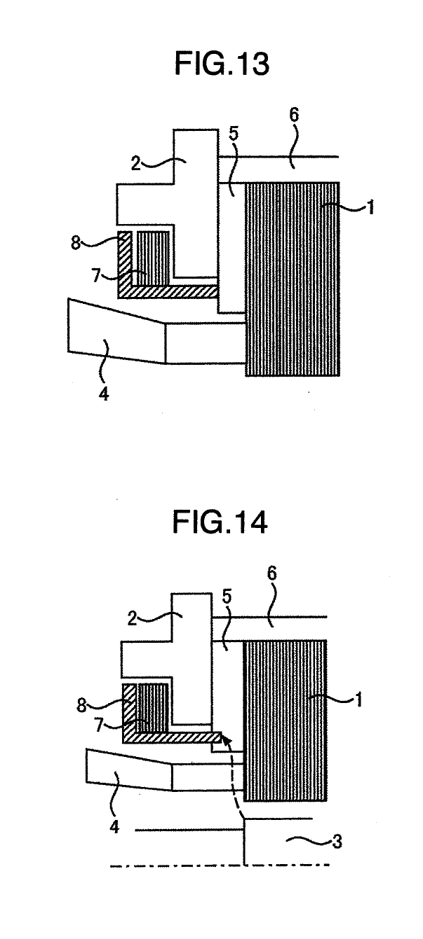

As shown in FIG. 13, this embodiment is structured that an end duct spacers 5 which make ventilation paths are arranged between the stator core 1 and the clamping plates 2 in the axial direction.

In this embodiment, the end duct spacers 5 make heat-absorbing ventilation ducts are made between the stator core 1 and the clamping plates 2, thereby improving cooling performance.

Further, as shown in FIG. 14, a groove is formed in an end face of the end duct spacer 5 in the axial direction and the powder magnetic core segment 8 is extended to the groove portion in the axial direction, so that magnetic flux that enters the clamping plates 2 from the end duct spacer 5 can be attracted to the powder magnetic core segment 8, thereby further reducing more loss in the clamping plates 2.

### Embodiment 4

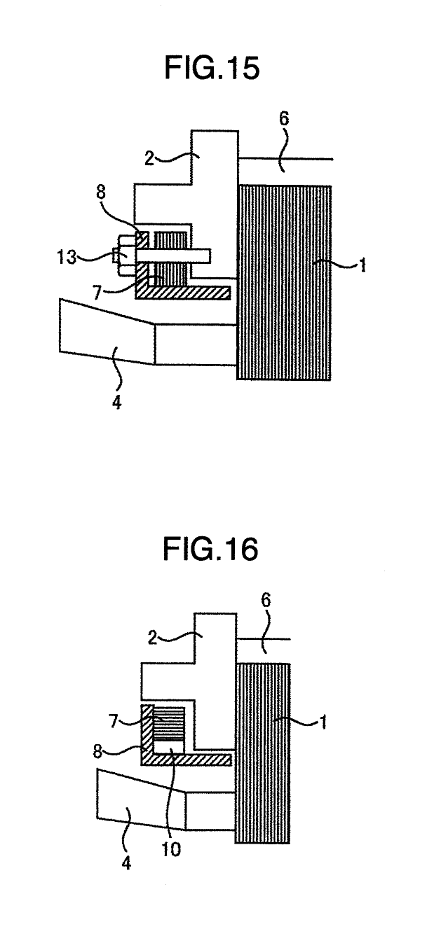

As shown in FIG. 15, the magnetic shield comprising the cylinder 7 of stacked steel sheets and the powder magnetic core segments 8 is fastened with a bolt 13 on the clamping plates 2, thereby improving the strength of the fastened part and making positioning easy. The bolt 13 may be made of a magnetic material, but if it is made of a nonmagnetic material, the loss in the bolt 13 is also reduced.

### Embodiment 5

In the aforementioned Embodiments 1 to 4, the cylinder 7 of stacked steel sheets is formed by stacking the steel sheets in the axial direction, but the cylinder 7 of stacked steel sheets may also be formed by stacking the steel sheets in the radial direction as shown in FIG. 16. In this case, the cylinder 7 of stacked steel sheets is jointed to the powder magnetic core segment 8 in the axial direction and an air gap or an insulator 10 is provided in the radial direction so that magnetic flux will flow in mostly from the stacking cross section and hence the eddy current losses in the stacked steel sheets will be reduced.

### Embodiment 6

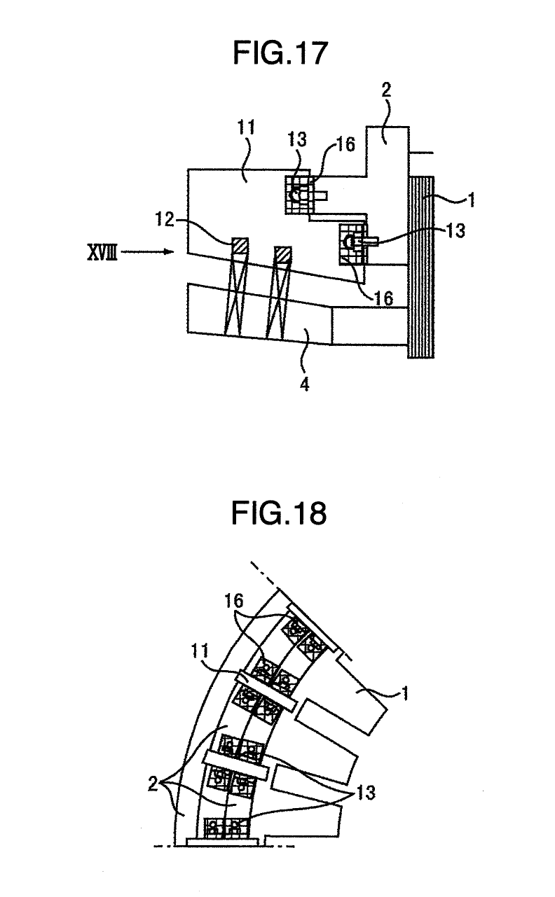

FIG. 17 shows a structure of a stator end part in a conventional electric rotating machine where plates which support coils 11 are jointed to the clamping plates 2. FIG. 18 is a view seen from an arrow XVIII in FIG. 17 except for coil support rings 12.

The plates which support coils 11 as shown is a nonmagnetic plate and multiple plates which support coils 11 exist in the circumferential direction. Further, a fixing plate 16 and a bolt 13 are used for fixation on the clamping plate 2. The plates which support coils 11 retain the coil support rings 12 and retains the stator winding 4 by fixing, with adhesive tape, the coil support rings 12 and the end parts of the stator winding 4.

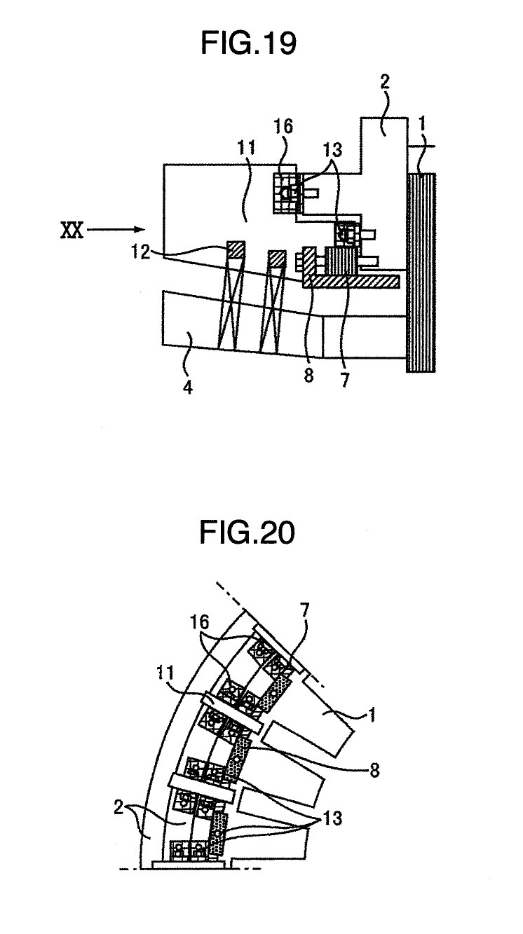

FIG. 19 and FIG. 20 show a structure in which the magnetic shield is placed without interfering with the plates which support coils 11.

As shown in FIG. 19, a fixing plate 16 of the plates which support coils 11 and the magnetic shield are so arranged that the positions will be shifted from each other in the radial direction to avoid interference. This structure enables the magnetic shield to reduce loss even in the electric rotating machine in which the plates which support coils 11 are placed.

### Embodiment 7

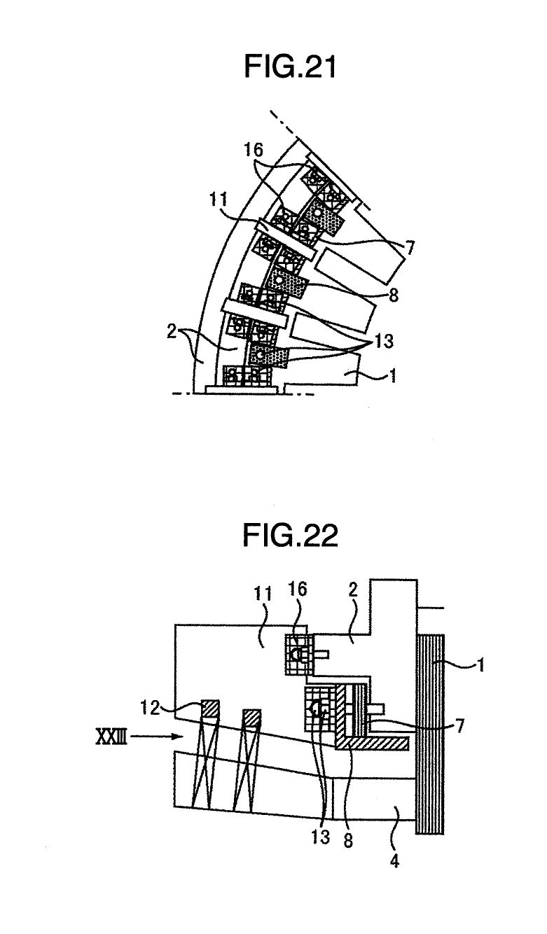

Like in Embodiment 7 shown in FIG. 21, if the positions of the fixing plate 16 of the plates which support coils 11 and the powder magnetic core segment 8 are shifted from each other in the circumferential direction, the magnetic shield can be more extended in the radial direction than that in Embodiment 6, thereby increasing an area in which the clamping plates 2 are covered with the magnetic shield and reducing the losses in the clamping plates.

### Embodiment 8

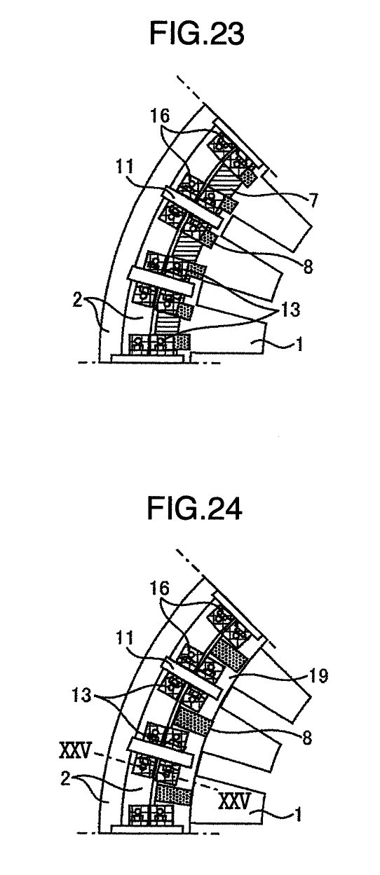

Like in Embodiment 8 shown in FIG. 22 and FIG. 23, the fixing plate 16 of the plates which support coils 11 and the bolt 13 of the magnetic shield may be used in common.

In this embodiment, the number of bolt holes drilled in the cylinder 7 of stacked steel sheets can be more reduced than that in Embodiment 6, so that the cross-section area of the flux path in the cylinder 7 of stacked steel sheets in the circumferential direction becomes large to reduce magnetic flux density, thereby reducing the loss in the cylinder 7 of stacked steel sheets.

### Embodiment 9

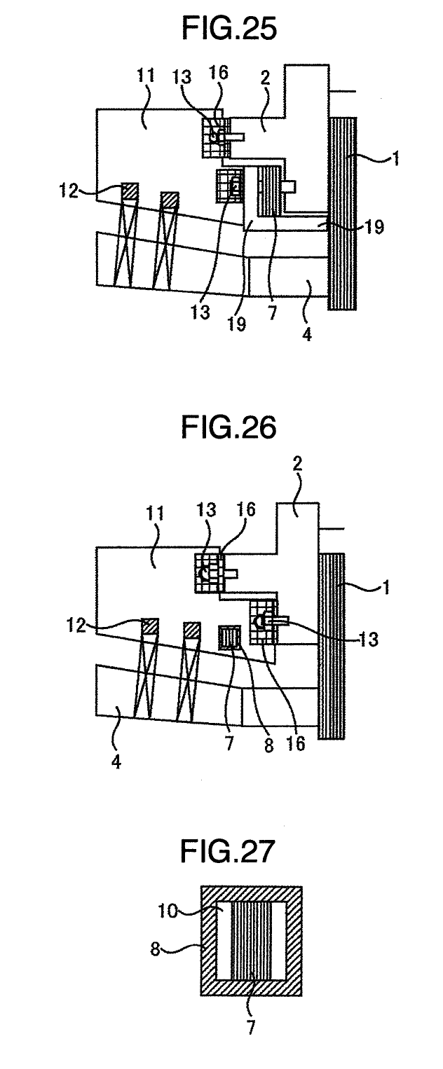

Powder magnetic core segments 8 are housed in the resin case 19 for multiple segments. Then, as shown in FIG. 24 and FIG. 25, the fixing plates 16 of the plates which support coils s 11 and the bolts 13 of the magnetic shield are used in common, and bolt holes are drilled in the resin case 19 for multiple segments and the magnetic shield is fastened with the bolts, so that the need to drill the bolt holes in the powder magnetic core segments 8 can be eliminated. This results in an increase in the cross-section area of the flux path in the powder magnetic core segment 8 and hence reduction in magnetic flux density, thereby reducing the hysteresis loss in the powder magnetic core segment 8.

### Embodiment 10

As shown in FIG. 26, the magnetic shield comprising the cylinder 7 made of stacked steel sheets and the powder magnetic core segment 8 is retained on the clamping plates 2 through the holes drilled in the multiple plates which support coils 11 placed in the circumferential direction so that flux leakage from the stator winding 4 can be shielded.

In this case, as shown in FIG. 27, the magnetic shield assumes a shape that insulators 10 are placed at both ends of the cylinder 7 of stacked steel sheets in the stacking direction and the insulators and the cylinder 7 of stacked steel sheets are surrounded by the powder magnetic core segment 8, so that magnetic flux can be flown into the cylinder 7 of stacked steel sheets from the stacking cross section, thereby suppressing eddy current loss that occurs in the cylinder 7 of stacked steel sheets.

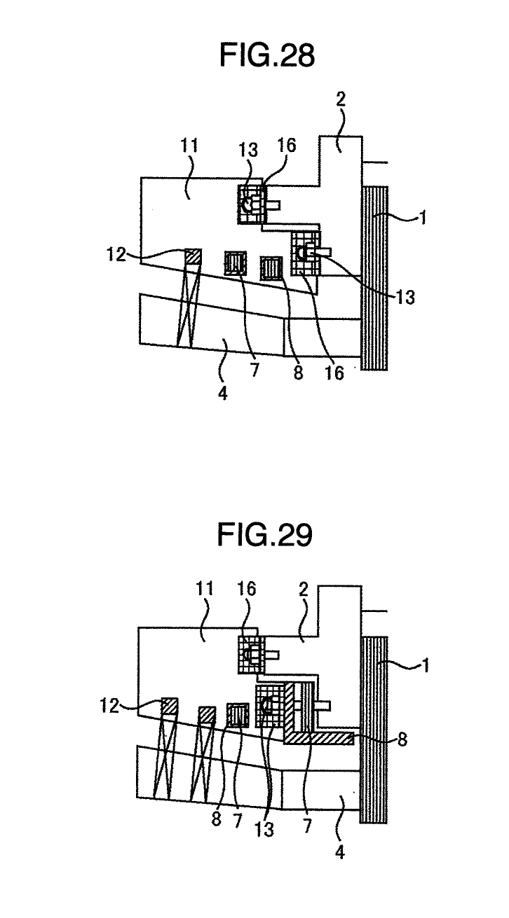

In FIG. 25, the magnetic shield is provided at one point alone, but magnetic shields may be provided at two or more points as shown in FIG. 28.

### Embodiment 11

The magnetic shield described in Embodiment 10 is used in combination with the magnetic shield described in Embodiment 1 as shown in FIG. 29 so that the amount of magnetic flux flowing into the clamping plates 2 can be reduced, thereby reducing losses that occur in the clamping plates 2.

### Embodiment 12

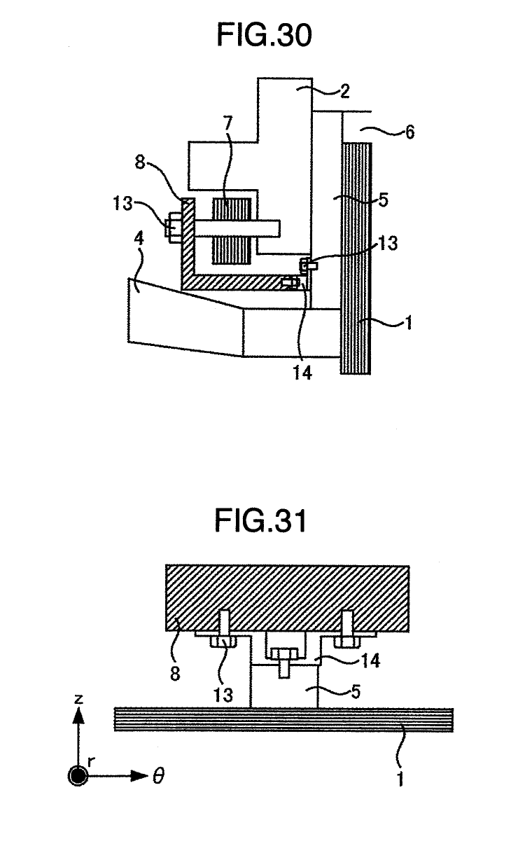

FIG. 30 and FIG. 31 show a structure in which a fixing jig 14 is inserted between the end duct spacer 5 and the powder magnetic core segment 8. In the figures, the jig 14 is attached to the end duct spacer 5 as shown in FIG. 31 to fix the powder magnetic core segment 8 so that the strength of retaining the magnetic shield can be increased. During assembly, the jig 14 and the powder magnetic core segment 8 are fastened with the bolts 13, and then the jig 14 and the end duct spacer 5 are fastened with the bolt 13. The positions of fastening the jig 14 and the end duct spacer 5 with the bolts are shifted from each other in the radial direction of the powder magnetic core segment 8, and this enables the end duct spacers 5 and the jig 14 to be fixed. The bolts 13 and the jig 14 may be made of a magnetic material, but if they are made of a nonmagnetic material, the loss in the bolts 13 and the jig 14 can be reduced.

### Embodiment 13

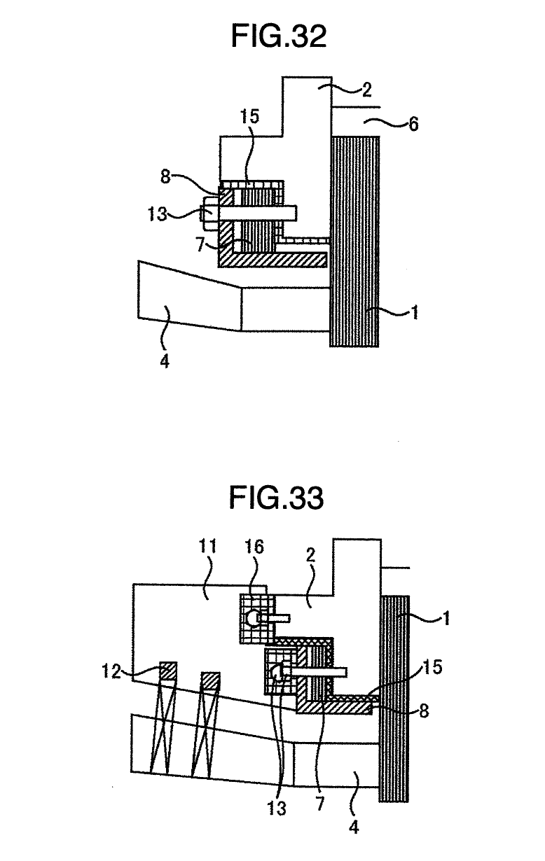

As shown in FIG. 32, a conductor plate 15 is arranged between the magnetic shield and the clamping plate 2, so that the amount of magnetic flux flowing into the clamping plate 2 will be further reduced, thereby reducing eddy current loss. Further, upon placing the plates which support coils 11, the magnetic shield and the conductor plate 15 can be fastened on the clamping plates 2 with bolts 13 used in common with the fixing plate 16 for the plates which support coils as shown in FIG. 33. Thus, the common use of the bolts 13 can reduce the number of parts.

### Embodiment 14

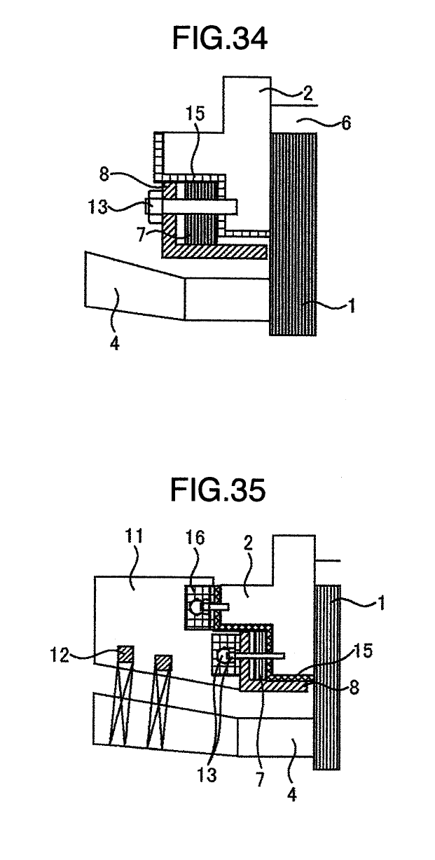

Like in FIG. 34, if the conductor plate 15 is placed on surfaces that are not covered with the magnetic shield, magnetic flux that has attempted to flow into the clamping plates 2 from the placed portions is bent by the reaction of the conductor plate 15 to make it easy for the magnetic flux to converge on the magnetic shield, so that the amount of magnetic flux flowing into the clamping plates 2 is further reduced and eddy current loss that occurs due to the magnetic flux to the clamping plates 2 is also reduced.

Further, as shown in FIG. 35, if the magnetic shield and the conductor plate 15 are fastened on the clamping plates 2 with bolts 13 used in common with the fixing plate 16, the number of joint parts can be reduced.

### Embodiment 15

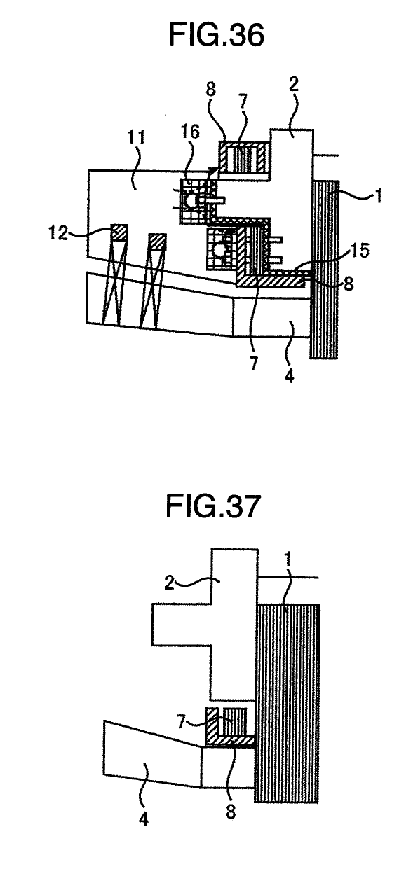

As shown in FIG. 36, if the magnetic shield is placed on the outer side of radial direction of the clamping plates 2, magnetic flux bent by the conductor plate 15 and headed to the outer side of radial direction of the clamping plates 2 can be attracted, and hence the amount of magnetic flux to the clamping plates 2 can be reduced, thereby reducing eddy current loss in the clamping plates 2.

In order to prevent magnetic flux from flowing into the clamping plates 2 from the magnetic shield, an insulator 10 is arranged between the magnetic shield and the clamping plates 2.

### Embodiment 16

As shown in FIG. 37, if the magnetic shield comprising the cylinder 7 of stacked steel sheets and the powder magnetic core segment 8 is placed to be stuck together with the outer side of radial direction of the stator winding 4 and shaped in the form of a cylinder about the axis of rotation, the stator winding 4 can support the magnetic shield, making it easier to retain it.

### Embodiment 17

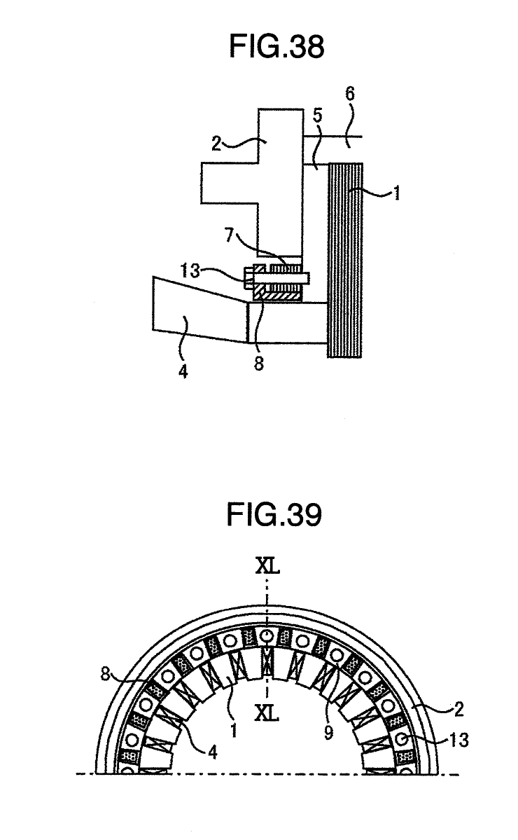

As shown in FIG. 38, if the cylinder 7 of stacked steel sheets and the powder magnetic core segment 8 are fastened on the end duct spacer 5 with a bolt 13, they can be fixed stronger. The bolt may be made of a magnetic material, but if a nonmagnetic material is used, the loss in the bolt 13 is also reduced.

### Embodiment 18

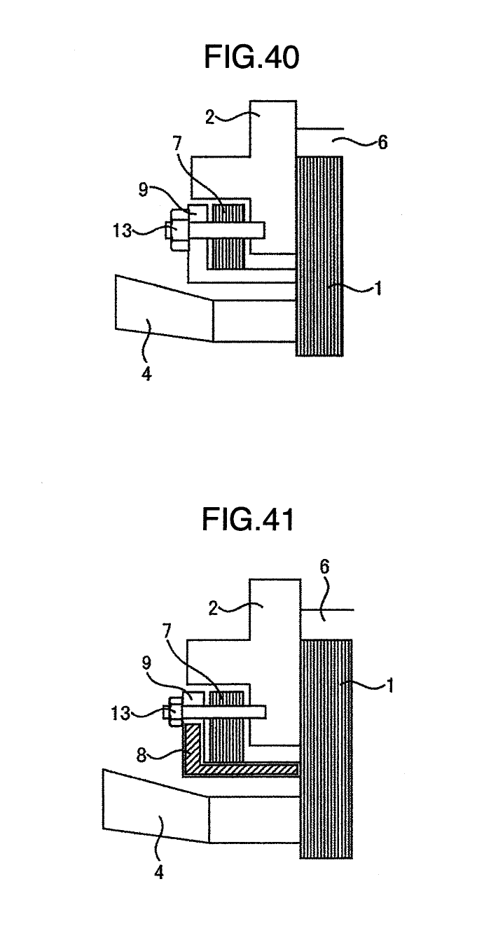

When the magnetic shield is fastened with bolts on the clamping plates 2, bolt holes are bored into the resin case 19 for multiple segments and the magnetic shield is fastened on the clamping plates 2 as shown in FIG. 39 and FIG. 40, the need to bore bolt holes in the powder magnetic core segment 8 is eliminated.

Thus, since there are no bolt holes in the powder magnetic core segment 8, the cross-section area of a flux path headed from the powder magnetic core segment 8 to the cylinder 7 of stacked steel sheets increases by one bolt hole to reduce magnetic flux density, thereby reducing hysteresis loss in the powder magnetic core segment 8.

### Embodiment 19

As shown in FIG. 41, a case 9 is extended over the powder magnetic core segment 8 in the radial direction and fixed holes are bored into the clamping plates 2 to eliminate the need to bore the bolt holes in the powder magnetic core segment 8. This increases the cross-section area of a flux path to the cylinder 7 of stacked steel sheets and reduces magnetic flux density, so that the hysteresis loss in the powder magnetic core segment 8 can be reduced.

The aforementioned embodiments take two-pole turbine generators as examples, but the present invention is, of course, applicable to a four-pole machine or electric rotating machines whose number of poles is more than four.

Further, the stacked steel sheets are used for the stator, and this is applicable to an electric rotating machine using clamping plates of a magnetic material in the steel sheet end parts.

It should be further understood by those skilled in the art that although the foregoing description has been made on embodiments of the invention, the invention is not limited thereto and various changes and modifications may be made without departing from the spirit of the invention and the scope of the appended claims.

1. An electric rotating machine comprising a rotor formed with field winding wound around a rotor core, a stator placed opposite to the rotor at a predetermined space and formed with stator winding wound around a stator core formed by stacking a plurality of magnetic steel sheets in an axial direction, clamping plates clamping and retaining the stator core from both axial end parts thereof in a stacking direction of magnetic steel sheets, and a magnetic shield placed around the clamping plates to shield flux leakage flowing into the clamping plates,
wherein said magnetic shield is formed of a cylinder of stacked steel sheets stacked in a form of a cylinder about a rotor shaft and powder magnetic core segments having portions which are stuck to said cylinder of stacked steel sheets on a stacking cross section, and arranged to cover side surfaces and inner surface of radial direction of the clamping plates.

2. The electric rotating machine according to claim 1, wherein air gaps or nonmagnetic insulators are provided between said cylinder of stacked steel sheets and said clamping plates and between said cylinder of stacked steel sheets and said powder magnetic core segments.

3. The electric rotating machine according to claim 1, wherein surfaces of said powder magnetic core segments are coated with resin.

4. The electric rotating machine according to claim 1, wherein said powder magnetic core segments are housed in a resin case one by one or plural by plural.

5. The electric rotating machine according to claim 4, wherein a bolt hole is bored in said resin case to fasten the resin case on the clamping plate using a bolt in the bolt hole.

6. The electric rotating machine according to claim 1, wherein a cylinder made of an amorphous core is used instead of said cylinder of stacked steel sheets.

7. The electric rotating machine according to claim 1, wherein said magnetic shield comprising said cylinder of stacked steel sheets and said powder magnetic core segments is retained by a plurality of plates which support coils placed on said clamping plates in a circumferential direction.

8. The electric rotating machine according to claim 1, wherein notches are provided in the axial direction in duct spacers located between said clamping plates and said stator core and projections are formed in said powder magnetic core segments so that said projections of said powder magnetic core segments are fitted in said notches of said duct spacers.

9. The electric rotating machine according to claim 1, wherein said powder magnetic core segments and said duct spacers are jointed through jigs.

10. The electric rotating machine according to claim 1, wherein conductor plates are placed between said magnetic shield and said clamping plates.

11. The electric rotating machine according to claim 10, wherein said conductor plates are also placed on surfaces of said clamping plates.

12. The electric rotating machine according to claim 1, comprising the magnetic shield in which both ends of said cylinder of stacked steel sheets in the stacking direction are covered with insulators.

13. The electric rotating machine according to claim 12, wherein an outer side of said magnetic shield is covered with a powder magnetic core cylinder to stick and retain said cylinder of stacked steel sheets and said powder magnetic core cylinder together in the radial direction through holes bored in plates which support coils retaining the stator winding.

14. The electric rotating machine according to claim 2, wherein said air gaps or insulators between said cylinder of stacked steel sheets and said clamping plates have dimensions in the stacking direction of said cylinder of stacked steel sheets, and if an coefficient of 0.6 is A, a square of a radius of said cylinder of stacked steel sheets is B, an inverse of relative permeability of said cylinder of stacked steel sheets is C, and an inverse of a stacking thickness of said cylinder of stacked steel sheets is D, said dimensions are larger than a product of A, B, C and D.

15. The electric rotating machine according to claim 2, wherein said air gaps or insulators between said cylinder of stacked steel sheets and said powder magnetic core segments have dimensions in the stacking direction of said cylinder of stacked steel sheets, and if a flux path length to a joint surface between said powder magnetic core segments and said cylinder of stacked steel sheets is A, an inverse of relative permeability of the powder magnetic core segments is B, and a value obtained by dividing a cross-section area of a flux path in said air gaps or insulators by a cross-section area of a flux path in said powder magnetic core segments is C, said dimensions are larger than a product of A, B and C.

16. The electric rotating machine according to claim 15, wherein if an coefficient of 1.2 is A, a square of a length of said powder magnetic core segment in the radial direction is B, an inverse of a thickness of said powder magnetic core segments in the axial direction is C, and an inverse of relative permeability of said powder magnetic core segments is D, said dimensions of said air gaps or insulators are set equal to or more than a product of A, B, C and D, and said dimensions are those of the stacking direction of said cylinder of stacked steel sheets.

17. An electric rotating machine comprising a rotor formed with field winding wound around a rotor core, a stator placed opposite to said rotor at a predetermined space and formed with stator winding wound around a stator core formed by stacking a plurality of magnetic steel sheets in an axial direction, clamping plates clamping and retaining said stator core from both axial end parts thereof in a stacking direction of the magnetic steel sheets, and a magnetic shield placed around said clamping plates to shield flux leakage flowing into said clamping plates,
wherein said magnetic shield is formed of a first member and a second member of a magnetic material, the first member is higher in magnetic permeability than said clamping plates and low in conductivity and has isotropically magnetic properties, the second member is higher in magnetic permeability than the first member and anisotropic in conductivity, and the second member assumes a form of a cylinder and has a joint surface to the first member in a direction in which the conductivity is high, the first member is placed on an axial end side and an inner side of radial direction of the second member.
